(19) United States
(12) Patent Application Publication
(10) Pub. No.: US 2023/0390161 A1
(43) Pub. Date: Dec. 7, 2023

(54) METHODS AND APPARATUS FOR DISPENSING A THERAPEUTIC AGENT

(71) Applicant: Papeltec Overseas, Inc., Atlantic Beach, FL (US)

(72) Inventor: Victor Rodriguez, Jacksonville, FL (US)

(73) Assignee: Papeltec Overseas, Inc., Atlantic Beach, FL (US)

(21) Appl. No.: 18/205,337

(22) Filed: Jun. 2, 2023

Related U.S. Application Data
(60) Provisional application No. 63/349,965, filed on Jun. 7, 2022.

(51) Int. Cl. A61J 7/00; A61J 17/02; A61D 7/00

(52) U.S. Cl. CPC A61J 7/0046; A61J 17/02; A61D 7/00

(57) ABSTRACT

A dispensing device for dispensing an ingestible material includes a compressible element. The compressible element includes a compressible pouch for containing the ingestible material and a chewable surface. The compressible element further includes at least one valve between the compressible pouch and the chewable surface. The valve is configured to prevent flow of the ingestible material when the compressible element is in an uncompressed state, and dispense the ingestible material when pressure is applied to the chewable surface. A method for administering an ingestible material includes containing the ingestible material in a compressible pouch, encasing the compressible pouch in a compressible element made of an elastic, nontoxic material, and having a chewable surface, and expelling the ingestible material to the chewable surface by applying pressure to the chewable surface.

### CROSS-REFERENCE TO RELATED APPLICATIONS

This application claims priority and the benefit to U.S. Provisional Patent Application No. 63/349,965 filed on Jun. 7, 2022, the contents of which is incorporated by reference in its entirety into the subject matter of the present application.

### FIELD OF THE DISCLOSURE

The present disclosure relates to methods and apparatus to administer a therapeutic agent via chewing action on a dispensing device.

### BACKGROUND OF THE DISCLOSURE

A human baby normally has twenty or more teeth below their gumline that must be brought through the surface of their gums through a process generally referred to as teething. Teething is often very painful and disruptive to the child and those around the child. Numerous medicines are used to treat teething discomfort, but it is often difficult to administer the minute doses suitable for a baby over a period of time.

Puppies also teethe and often experience considerable discomfort which causes them to act out. Teething puppies can also cause considerable damage to household items, including furniture, electronic controls, and owner's phones due to chewing to relieve their pain. Similar to an infant, it is often difficult to administer a therapeutic agent to a puppy over a period of time.

Therefore, methods and apparatus for providing relief of a teething condition without constant intervention by a responsible adult are needed.

### SUMMARY OF THE DISCLOSURE

Accordingly, the present invention provides methods and apparatus for allowing a teething mammal to self soothe by chewing on a chewable surface of a dispensing device. The chewable surface is in fluid communication with an interior pouch of the dispensing device that is responsive to the chewing action to dispense a therapeutic agent directly into the teething mammal's mouth and preferably onto the site of teething discomfort.

Embodiments of the present disclosure may include a method and apparatus for administering a therapeutic agent to an infant. A therapeutic agent, as used herein, includes an ingestible fluid or viscous material such as a liquid, gel, or cream that contains active ingredients that can be used to relieve pain, relieve anxiety, or address other symptoms or conditions. In some embodiments, a therapeutic agent may include a liquid with a viscosity of 1-10 cps. In other embodiments, a therapeutic agent may be more viscous and include a substance of between about 100 cps and 2,000,000. However, the present invention is not necessarily limited by degrees of viscosity, such that while a viscosity of between about between about 1.00 (viscosity of water at degrees Celsius) and 2,000,00 (viscosity of lard at room temperature) may be preferred, other viscosities are within the scope of the invention unless specifically limited by an issued claim. The method includes containing the therapeutic agent in a compressible pouch and encasing the compressible pouch in a compressible element made of an elastic nontoxic material and having a chewable surface. At least one alignment valve (or other valve) is positioned in the compressible element between the compressible pouch and the chewable surface. As pressure is applied to the chewable surface, such as, for example, via chewing on the chewable surface, the pressure places the alignment valve into a compressed state that aligns the alignment valve and thereby provides fluid communication between the pouch and the chewable surface.

The pressure from chewing further causes a dispensing of an amount of the therapeutic agent from the compressible pouch via the alignment valve (or other valve) to the chewable surface. Embodiments may also include releasing the alignment valve from the compressed state and thereby ceasing the fluid communication between the pouch and the chewable surface.

The description below is directed to dispensing therapeutic agents as a non-limiting example. The apparatus and methods disclosed herein can also be used to dispense other fluid, ingestible materials, such as water, juice, pureed foods, etc., with or without active ingredients.

### BRIEF DESCRIPTION OF THE DRAWINGS

The accompanying drawings, which are incorporated in and constitute a part of this specification, illustrate several embodiments of the disclosure and, together with the description, serve to explain the principles of the disclosure:

FIG. 1 illustrates an exemplary device according to some embodiments of the present invention.

FIG. 2A illustrates an exemplary alignment valve in a non-communicative state.

FIG. 2B illustrates the exemplary alignment valve of FIG. 2A in a communicative state.

FIG. 3A illustrates a plated one-way valve in a communicative state.

FIG. 3B illustrates the plated one-way valve of FIG. 3A in a non-communicative state.

FIG. 4 illustrates a variety of silicon one-way valves.

FIG. 5 illustrates a channel including two valves and a sealing area between the two one-way valves.

FIG. 6 illustrates a flowchart of an exemplary method including method steps that may be executed in some implementations of the present invention.

### DETAILED DESCRIPTION

The present disclosure provides generally for apparatus and methods for administering a therapeutic agent to the oral area of a mammal such as a puppy, primate, or a human baby. The administration of the therapeutic agent is controlled by a chewing motion on a chewable surface of a compressible element of a dispensing device. The chewing motion manipulates the functioning of a valve deployed to enable passage of the therapeutic agent from a compressible pouch to a chewable surface of the dispensing device.

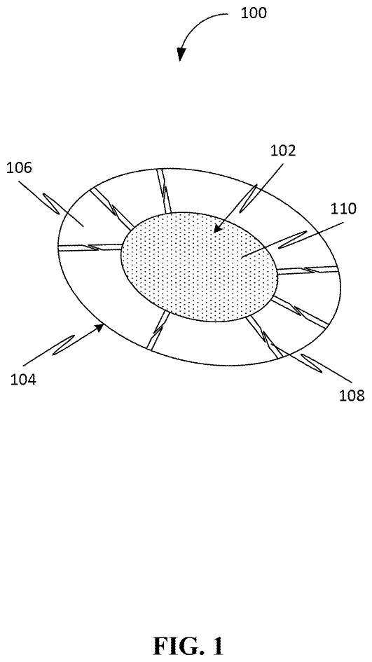

Referring now to FIG. 1, a compression activated therapeutic agent dispensing device 100 is illustrated. The dispensing device 100 includes a compressible pouch 102 formed in a compressible element 104 made of an elastic, nontoxic material. The compressible element 104 includes a chewable surface 106 and at least one valve 108 arranged between the compressible pouch 102 and the chewable surface 106.

The compressible pouch 102 is configured to contain a therapeutic agent 110 which may be, for example, a therapeutic agent for pain relief. The compressible element 104 is formed into a size and shape conducive to providing the chewable surface 106 that conveys compressive forces to the compressible pouch 102 and also provide conditions enabling fluidic communication through the at least one valve 108 encased in (or formed by) the compressible element 104. The compressible element 104, may, for example, be made of an elastic, nontoxic material.

In an uncompressed state, for example during storage, or otherwise during non-use, the dispensing device 100 is configured such that the valve 108 is closed (non-communicative). The flow of the therapeutic agent 110, contained in the compressible pouch 102, to the chewable surface 106 is prevented (blocked) by the valve 108 in the closed state.

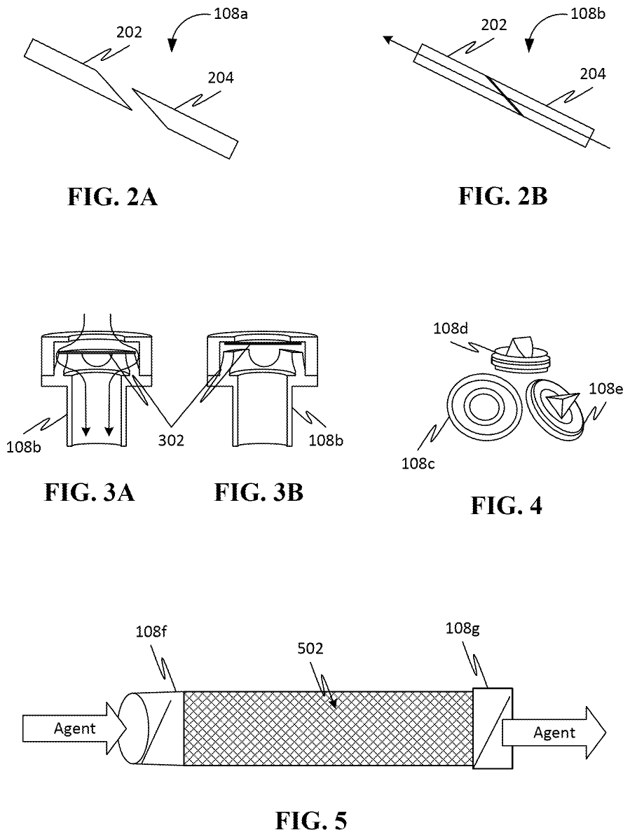

Compressing the compressible element 104 (such as, for example, compression caused by chewing on the chewable surface 106 or pressing down on the chewable surface 106) can provide force on the compressible pouch 102, which expels some of the therapeutic agent 110 from the compressible pouch 102 outward through the valve 108 to the chewable surface 106. In the case that the valve 108 is an alignment valve, the compression may further act to align channels of the alignment valve to establish fluid communication between the compressible pouch 102 and the chewable surface 106. This is described in additional detail below in reference to FIGS. 2A and 2B.

Releasing the pressure on the compressible element 104 releases the compressive force on the compressible pouch 102 such the therapeutic agent 110 is no longer forced through the valve 108. In some cases, the valve 108 may also revert to a rest (non-communicative) state by the release of the compressive force on the chewable surface 106, thereby discontinuing the flow of the therapeutic agent 110 from the compressible pouch 102 and the chewable surface 106.

The dispensing device 100 may include only the compressible element 104 or may include additional elements. For example, the dispensing device 100 may be in the form of a pacifier having a handle and mouth shield, wherein the elongated teat of the pacifier includes the compressible element 104. As another example, the dispensing device 100 may be or be included in a bone-shaped (or other shaped) chewable dog toy.

In preferred embodiments, one or both of the compressible element 104 and the therapeutic agent 110 is flavored in a manner suitable for an intended user and to which the intended user may be accustomed. For example, for canine use, the elastic material and/or the therapeutic agent may be flavored using ingredients typically found in puppy treats or food and to which canines may be accustomed. Similarly, for use with a human baby a flavor may emulate a formula or mother's milk flavor to which infants may be accustomed.

In embodiments meant for human deployment, the material used to form the compressible element 104 is preferably silicon, such as the material typically used to manufacture a baby pacifier. Canine use may require a more resilient material, such as a benign thermoplastic or nylon material.

In some embodiments compression of the compressible element 104 (such as, for example compression caused by chewing or pressing down on the chewable surface 106) manipulates a position/state of a valve 108, thereby permitting fluid communication through the valve 108. As an example, FIGS. 2A and 2B illustrate an operation of an alignment valve 108a that may be formed/encased in the compressible element 104.

As illustrated in FIGS. 2A and 2B, the alignment valve 108a includes a first channel 202 and a second channel 204. The alignment valve 108a only provides fluid communication through the alignment valve 108a when the two channels 202, 204 on either side of a fluidic break are aligned. FIG. 2A illustrates a state in which the two channels 202, 204 are in an unaligned state, and no fluid can flow. In an example, the alignment valve 108a is configured to be in this rest (non-communicative) state when no pressure is being applied to the compressible element 104. This rest (non-communicative) state prevents the therapeutic agent from leaking when the dispensing device 100 is stored and further seals the compressible pouch 102 from a potentially contaminating ambient environment.

FIG. 2B illustrates a state in which the two channels 202, 204 are fully aligned, and the alignment valve 108a is able to carry fluid at full capacity. In an example, the alignment valve 108a may assume this fully communicative state when pressure above a certain threshold (for example, strong chewing) is applied to the compressible element 104. In an example, the two channels 202, 204 of the alignment valve 108a move progressively into alignment with increasing pressure on the compressible element 104, such that an amount of therapeutic agent flowing through the alignment valve 108a increases with increasing pressure applied to the compressible element 104.

Additionally, or alternatively, the valves 108 formed or encased in the compressible element 104 may be or include one-way valves. One-way valves may be operational to allow the therapeutic agent 110 to exit the compressible pouch 102 to the chewable surface 106 when the pressure on the compressible pouch 102 generates an expelling force on the therapeutic agent that exceeds a predetermined threshold force. The expelling force opens the one-way valve, into an open position, and moves at least a portion of the therapeutic agent within the compressible pouch 102 through the one-way valve and onto the chewable surface 106. As the expelling force is relieved, the one-way valve will close into a non-communicative state.

With the one-way valve in the closed position, the one-way valve hygienically seals the therapeutic agent from a potentially contaminating environment and simultaneously impedes the flow from escaping the compressible pouch 102.

FIGS. 3A and 3B illustrate a one-way plate valve 108b that may be used as a valve 108 for the dispensing device 100. The one-way plate valve 108b includes a plate 302 that can be displaced by pressure, for example when pressure is applied on the compressible pouch 102 containing the therapeutic agent 110.

FIG. 3A illustrates a communicative state of the one-way plate valve 108b. In this state, the pressure on the therapeutic agent 110 displaces the plate 302, providing fluidic communication through the one-way plate valve 108b, such that the therapeutic agent 110 may flow from the compressible pouch 102 through the one-way plate valve 108b to the chewable surface 106.

FIG. 3B illustrates a non-communicative state of the one-way plate valve 108b. When pressure is released from the compressible pouch 102, the plate 302 may, through elastic force, return to a non-communicative position. This prevents the therapeutic agent (and possible contaminants) from flowing back into the compressible pouch 102 after having once been expelled.

FIG. 4 illustrates a variety of silicon one-way valves 108c-108e. These silicon one-way valves 108c-108e permit fluid communication in one direction when pressure is applied to one side of the one-way valves 108c-108e, and may assume a non-communicative, rest state when the pressure is released.

FIG. 5 illustrates a channel 500 for conducting therapeutic agent 110 from the compressible pouch 102 to the chewable surface 106. The channel 500 includes two valves 108f and a sealing area 502 located in the channel 500 between the two valves 108f. The two valves 108f may be alignment valves such as the alignment valve 108a described above. The two valves 108f may further be one-way valves such as the one-way valves 108b-108e described above. In operation, the channel 500 allows the therapeutic agent 110 to flow from the compressible pouch 102 to the chewable surface 106 when pressure is applied to the compressible pouch 102. When the pressure is released, the two valves 108f may close (i.e., assume a non-communicative state). The closing of the two valves 108f may cause an amount of the therapeutic agent 110 to be retained within the sealing area 502. This may serve as a barrier to prevent the therapeutic agent 110 that had passed beyond the channel 500 (and possible contaminants) from flowing backward through the channel 500 into the compressible pouch 203.

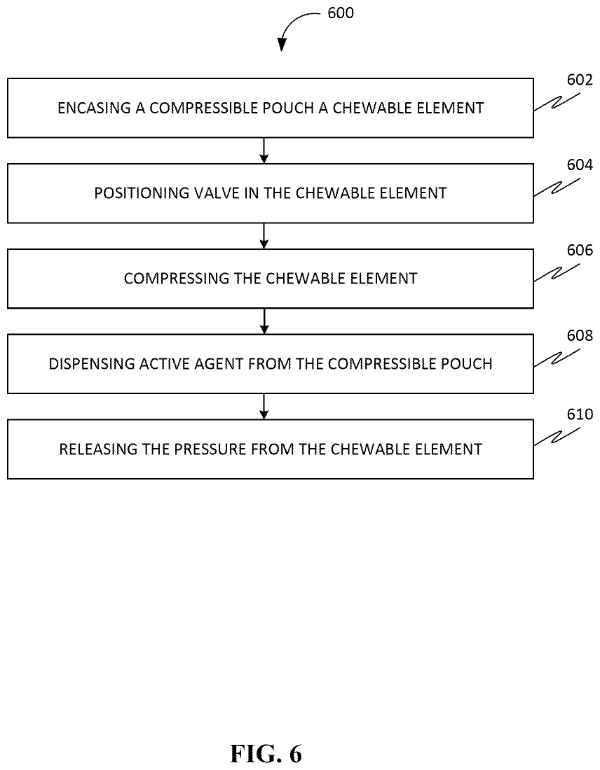

Referring now to FIG. 6, a flowchart illustrates a method 600 including method steps that may be executed to administer a therapeutic agent to a mammal such as a puppy, primate, or a human baby, according to some embodiments of the present disclosure. As a non-limiting example, the method 600 will be described in reference to the dispensing device 100. The method begins with a step 602.

At the step 602, a compressible pouch 102 is formed and/or encased in a compressible element 104 made of an elastic, nontoxic material. The compressible element 104 includes a chewable surface 106. The compressible pouch 102 contains a volume of a therapeutic agent 110. The therapeutic agent 110 may be a therapeutic agent to provide relief for a symptom being experienced by a mammal, such as a small child or animal. The symptom may be related to an oral condition, such as teething, or to a more systemic condition, such as anxiety. The therapeutic agent may be topical (such as, for example, an anesthetic meant to relieve teething pain), or may be systemic (such as, for example, a calming agent to relieve anxiety).

At step 604, a valve 108 (e.g., an alignment valve 108a) is positioned between the agent 110 in the compressible pouch 102 and the chewable surface 106. When no pressure is applied to the chewable surface 106 the valve 108 is in a rest (non-communicative) state and prevents fluid communication of the therapeutic agent 110 from the compressible pouch 102 to the chewable surface 106. In an example, the valve 108 may be an alignment valve 108a having two channels 202, 204 as described above. In the rest state, the two channels 202, 204 may be in a state of non-alignment, such that no therapeutic agent 110 can flow through the alignment valve 108a. In another example, the valve 108 may be a one-way valve such as the one-way valves 202b-202e described above.

At step 606, the valve 108 is activated to provide fluid communication of the therapeutic agent 110 between the compressible pouch 102 and the chewable surface 106. For example, in the case of an alignment valve 108a, the two channels 202, 204 of the alignment valve 108a can be aligned in response to pressure applied to the chewable surface 106, allowing the therapeutic agent 110 to flow through the alignment valve 108a. The pressure applied to the chewable surface 106 may be, for example, a result of chewing by a user on the chewable surface 106 of the compressible element 104. The user may be a mammal such as a small child or animal.

At step 608, an amount of the therapeutic agent 110 is dispensed from the compressible pouch 102 to the chewable surface 106. Pressure on the chewable surface 106 forces the agent 110 from the compressible pouch 102 through the valve 108 to the chewable surface 106. In some cases, for example, in the case of an alignment valve 108a, the valve 108 may also respond to the pressure applied to the chewable surface 106 to assume a communicative state, enabling the flow of the agent 110.

At step 610, pressure is released from the chewable surface 106, resulting in pressure being released from the compressible pouch 102 and the valve 108. The valve 108 assumes a non-communicative state and flow of the therapeutic agent 110 is blocked. In the case of an alignment valve 108a, the two channels 202, 204 assume a state of non-alignment and the fluid communication between the compressible pouch 102 and the chewable surface 106 is broken. In the case of a one-way wave 108b-108e, the reduced pressure of the agent allows the one-way valve 108b-108e to assume a non-communicative (closed) state. With the valve 108 in a non-communicative state, the remaining therapeutic agent 110 is retained in the compressible pouch 102.

In the preceding sections, detailed descriptions of examples and methods of the disclosure have been described. The description of both preferred and alternative examples though thorough are exemplary only, and it is understood that to those skilled in the art that variations, modifications, and alterations may be apparent. It is therefore to be understood that the examples do not limit the broadness of the aspects of the underlying disclosure as defined by the claims.

### CONCLUSION

A number of embodiments of the present disclosure have been described. While this specification contains many specific implementation details, they should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description thereto are not intended to limit the present disclosure to the form disclosed, but to the contrary, the present disclosure is to cover all modification, equivalents and alternatives falling within the spirit and scope of embodiments of the present disclosure as defined by the appended claims.

For example, the present invention may include a dispensing device for dispensing ingestible material, and methods of use of the dispensing device. The dispensing device may include a compressible element. The compressible element may include a compressible pouch for containing the ingestible material, a chewable surface; and at least one valve between the compressible pouch and the chewable surface. The valve may be configured to prevent flow of the ingestible material when the compressible element is in an uncompressed state, and dispense the ingestible material when pressure is applied to the chewable surface.

Implementations may include one or more of the following features. The compressible element may be configured such that the pressure applied to the chewable surface applies a pressure on the compressible pouch, thereby providing force to expel the ingestible material through the at least one valve. The at least one valve may be an alignment valve including two channels. The alignment valve may be configured such that the two channels are in an unaligned state when the compressible element is in an uncompressed state, and the two channels move into alignment when the pressure is applied to the chewable surface. The alignment of the two channels of the alignment valve may increase with increasing pressure applied to the chewable surface. The at least one valve may be a one-way valve. The at least one valve may be closed (non-communicative) when no pressure is applied to the chewable surface; and the pressure applied to the chewable surface may force the ingestible material through the valve to the chewable surface. The ingestible material may be a therapeutic agent. The ingestible material may be a topical agent. The compressible element may be made of an elastic, nontoxic material. The elastic, nontoxic material may be silicon or a benign thermoplastic or nylon material. The compressible element and/or ingestible material may be flavored in a manner to which an intended user may be accustomed. In an example, the compressible element and/or ingestible material may be flavored to emulate formula or mother's milk.

One general aspect includes a method for administering an ingestible material. The method includes containing the ingestible material in a compressible pouch; encasing the compressible pouch in a compressible element made of an elastic, nontoxic material, and having a chewable surface; and expelling the ingestible material to the chewable surface by applying pressure to the chewable surface.

Implementations may include one or more of the following features. The ingestible material may be a therapeutic agent. The pressure may be applied by chewing on the chewable surface. An amount of the ingestible material dispensed from the compressible pouch may increase with increased pressure on the chewable surface. Valves may be formed or encased in the compressible element between the compressible pouch and the chewable surface and applying pressure to the chewable surface may allow the ingestible material to flow through the valves. The valves may be alignment valves including two channels, and applying the pressure to the chewable surface may move the two channels of the alignment valves into alignment, thereby allowing the flow of the ingestible material. The valves may be one-way valves, and applying the pressure to the chewable surface may increase the pressure on the ingestible material in the compressible pouch, thereby forcing the ingestible material through the one-way valve to the chewable surface.

In some embodiments, the method may include discontinuing a flow of the ingestible material by discontinuing the application of pressure to the chewable surface.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The tem “a” or “an” entity refers to one or more of that entity. As such, the terms “a” (or “an”), “one or more” and “at least one” can be used interchangeably herein. It is also to be noted the terms “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A dispensing device for dispensing an ingestible material, comprising:
a compressible element including:
a compressible pouch for containing the ingestible material;
a chewable surface; and
at least one valve between the compressible pouch and the chewable surface, the at least one valve configured to prevent flow of the ingestible material when the compressible element is in an uncompressed state, and dispense the ingestible material when pressure is applied to the chewable surface.

2. The dispensing device of claim 1, wherein the compressible element is configured such that the pressure applied to the chewable surface applies a pressure on the compressible pouch, thereby providing force to expel the ingestible material through the at least one valve.

3. The dispensing device according to claim 1, wherein:
the at least one valve is an alignment valve including two channels; and
the alignment valve is configured such that the two channels are in an unaligned state when the compressible element is in the uncompressed state, and the two channels move into alignment when the pressure is applied to the chewable surface.

4. The dispensing device according to claim 3, wherein the alignment of the two channels of the alignment valve increases with increasing pressure applied to the chewable surface.

5. The dispensing device according to claim 1, wherein:
the at least one valve is a one-way valve;
the at least one valve is closed (non-communicative) when no pressure is applied to the chewable surface; and
the pressure applied to the chewable surface forces the ingestible material through the at least one valve to the chewable surface.

6. The dispensing device according to claim 1, wherein the ingestible material is a therapeutic agent.

7. The dispensing device according to claim 1, wherein the ingestible material is a topical agent.

8. The dispensing device according to claim 1, wherein the compressible element is made of an elastic, nontoxic material.

9. The dispensing device according to claim 8, wherein the elastic, nontoxic material is silicon.

10. The dispensing device according to claim 8, wherein the elastic, nontoxic material is a benign thermoplastic or nylon material.

11. The dispensing device according to claim 1, wherein the compressible element and/or the ingestible material is flavored in a manner to which an intended user may be accustomed.

12. The dispensing device according to claim 1, wherein the compressible element and/or the ingestible material is flavored to emulate formula or mother's milk.

13. A method for administering an ingestible material, comprising:
containing the ingestible material in a compressible pouch;
encasing the compressible pouch in a compressible element made of an elastic, nontoxic material, and having a chewable surface; and
expelling the ingestible material to the chewable surface by applying pressure to the chewable surface.

14. The method according to claim 13, wherein the ingestible material is a therapeutic agent.

15. The method according to claim 14, wherein the pressure is applied by chewing on the chewable surface.

16. The method according to claim 15, wherein an amount of the ingestible material dispensed from the compressible pouch increases with increased pressure on the chewable surface.

17. The method of claim 14, wherein valves are formed or encased in the compressible element between the compressible pouch and the chewable surface and applying the pressure to the chewable surface allows the ingestible material to flow through the valves.

18. The method of claim 17, wherein the valves are alignment valves including two channels, and applying the pressure to the chewable surface moves the two channels of the alignment valves into alignment, thereby allowing the flow of the ingestible material.

19. The method of claim 17, wherein the valves are one-way valves, and applying the pressure to the chewable surface increases a pressure on the ingestible material in the compressible pouch, thereby forcing the ingestible material through the one-way valves to the chewable surface.

20. The method of claim 14, further comprising:
discontinuing a flow of the ingestible material by discontinuing the application of pressure to the chewable surface.
